(19) United States
(12) Patent Application Publication
(10) Pub. No.: US 2007/0053732 A1
(43) Pub. Date: Mar. 8, 2007

(54) IMAGE FORMING DEVICE

(75) Inventor: Ariyoshi HIKOSAKA, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/469,908

(22) Filed: Sep. 5, 2006

(30) Foreign Application Priority Data
Sep. 8, 2005 (JP) 2005-261041

(51) Int. Cl. G03G 21/00

(52) U.S. Cl. 399/366

(57) ABSTRACT

An image forming device is disclosed which can easily and promptly execute a copy restriction process that restricts the copying of an original document based on a background pattern included in the original document image that is obtained by scanning the original document. In the restriction process, when an original document is scanned, the number of lines (i.e., lines per inch) in the background pattern included in the original document image will be detected. Then, it will be determined whether the detected number of lines per inch is a predetermined number of lines per inch (e.g., less than 65 LPI). Based on the determination result, the copying of the original document will either be permitted or restricted.

### CROSS-REFERENCE TO RELATED APPLICATIONS

This application claims priority to Japanese Patent Application No. 2005-261041. The entire disclosure of Japanese Patent Application No. 2005-261041 is hereby incorporated herein by reference.

### BACKGROUND OF THE INVENTION

1. Field of the Invention

The present invention relates to an image forming device in which copying of an original document is executed based on an image of the original document obtained by scanning the original document, and in particular to an image forming device with a copy restriction function that restricts the copying of the original document based on background patterns included in the image of the original document.

2. Background Information

An image forming device with a copy restriction function that restricts (or prohibits) the copying of an original document based on background pattern embedded in an image of the original document that is obtained by scanning the original document is known, and is disclosed, for example, in Japan Patent Application Publication JP-A-2004-274092. Restriction data for restricting copying is stored in advance in this type of image forming device. When copying is to be executed, it will be determined whether restriction data is included in the background pattern embedded in the image of the original document obtained by scanning the original document. If it is determined that the restriction information is included in the background pattern, copying of the original document will be restricted. In general, a background pattern including restriction data is expressed as a complex irregular pattern so as to distinguish the background pattern from simple patterns (e.g., designs or patterns to be printed in the background of a normal original document).

However, if the background pattern included in the image of the original document is a complex irregular pattern, it will be difficult to promptly determine if the restriction data is included in the background pattern, that is, whether copying of the original document will be permitted. Accordingly, one problem that will be caused is that the time required for executing copying will be prolonged. In addition, a storage region for storing a plurality of types of restriction data (i.e., background patterns) used for comparing/matching with the scanned background pattern will be required in some cases. Furthermore, another problem is that the process steps and the circuit configuration for comparing the restriction information and the scanned background pattern will be complicated, because of the complexity of the restriction data and the scanned background pattern.

In view of the above, it will be apparent to those skilled in the art from this disclosure that there exists a need for an improved image forming device that can easily and quickly execute a copy restriction process for restricting the copying of an original document if a certain type of background pattern is included in the image of the original document that is obtained by scanning the original document. This invention addresses this need in the art as well as other needs, which will become apparent to those skilled in the art from this disclosure.

### SUMMARY OF THE INVENTION

For the purpose of achieving the above described object, the present invention is applied to an image forming device for copying an original document based on an image of the original document obtained by scanning the original document, and is configured to detect the number of lines (hereinafter referred to as “lines per inch” or simply “LPI”) in the background pattern included in the original document image, and restrict copying of the original document based on the detected number of lines in the background pattern.

According to the present invention, it will not be necessary to execute a complicated process such as an analysis of a complex irregular background pattern as in the conventional art, and copying of an original document can be restricted based on the number of lines per inch in the background pattern. Therefore, it can be promptly determined whether copying can be performed, and thus it will be possible to reduce the time required to execute copying. In other words, the background pattern may be a simple regular pattern as long as the number of lines per inch therein can be determined. In addition, it is not necessary to store a plurality of types of restriction data (i.e., a plurality of types of background patterns) in order to restrict copying of the original document. Therefore, it will be possible to reduce the storage region for storing the data. Furthermore, it will not be necessary to execute a complicated process for comparing the background pattern included in the original document image with the restriction data. Therefore, the process steps for determining whether or not copying of the original document is permitted can be simplified, as well as and circuit configuration.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing the overall configuration of a multifunction device according to a first embodiment of the present invention;

FIG. 2 is a block diagram showing a lines per inch detector mounted on a multifunction device according to the first embodiment of the present invention;

FIG. 3A is a diagram showing a 17×17 matrix Gaussian filter;

FIG. 3B is a diagram showing the frequency characteristics of the Gaussian filter;

FIG. 4 is a flow chart showing an example of the steps of a copy process conducted by a control unit in a multifunction device according to the first embodiment of the present invention; and

FIG. 5 is a block diagram showing a lines per inch detector mounted on a multifunction device according to a second embodiment of the present invention.

### DETAILED DESCRIPTION OF THE PREFERRED EMBODIMENTS

Selected embodiments of the present invention will now be explained with reference to the attached drawings to understand the present invention. Note that it will be apparent to those skilled in the art from this disclosure that the following descriptions of the embodiments of the present invention are provided for illustration only and not for the purpose of limiting the invention as defined by the appended claims and their equivalents.

### First Embodiment

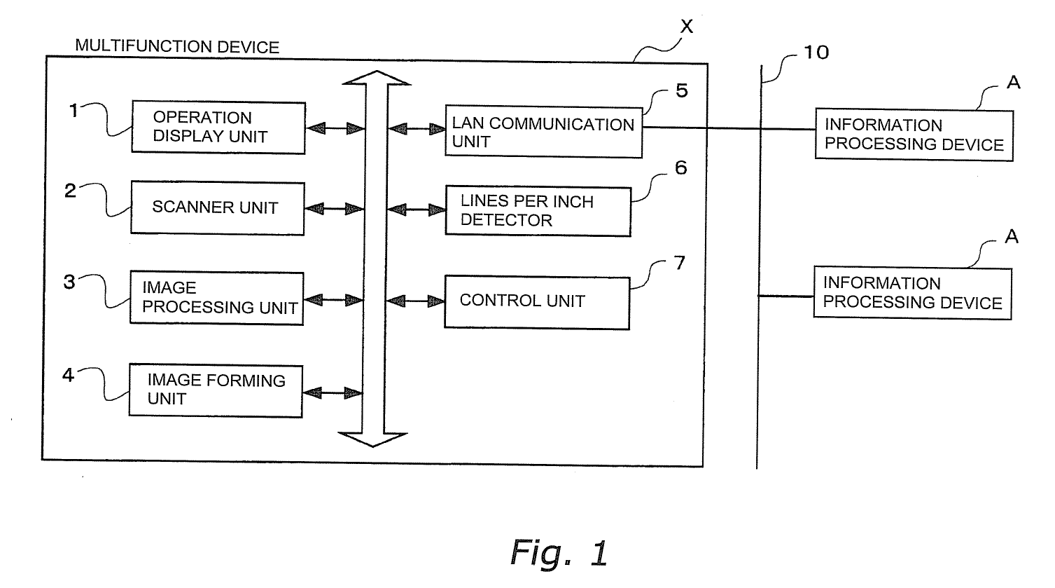

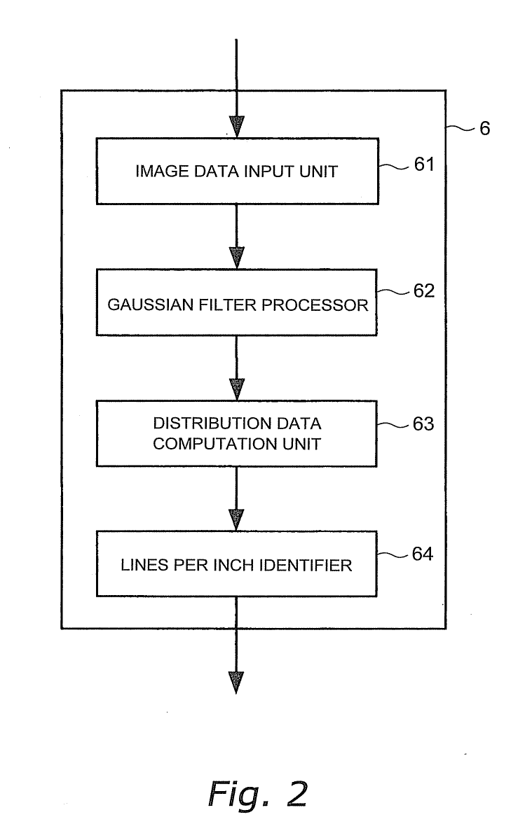

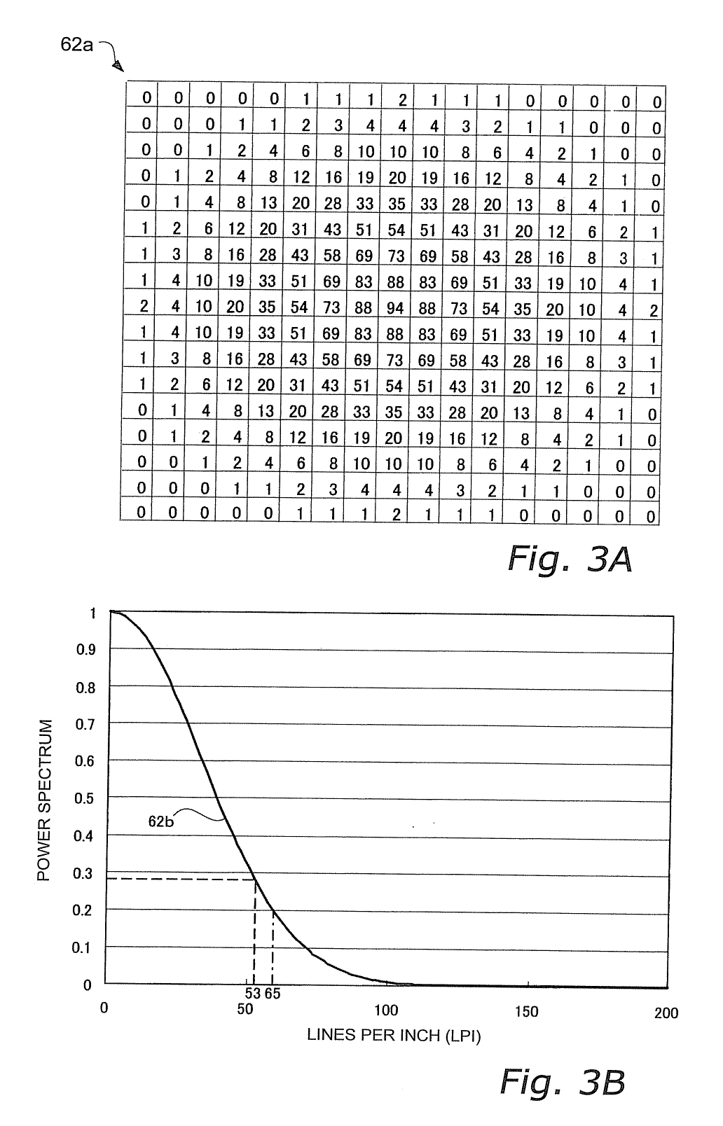

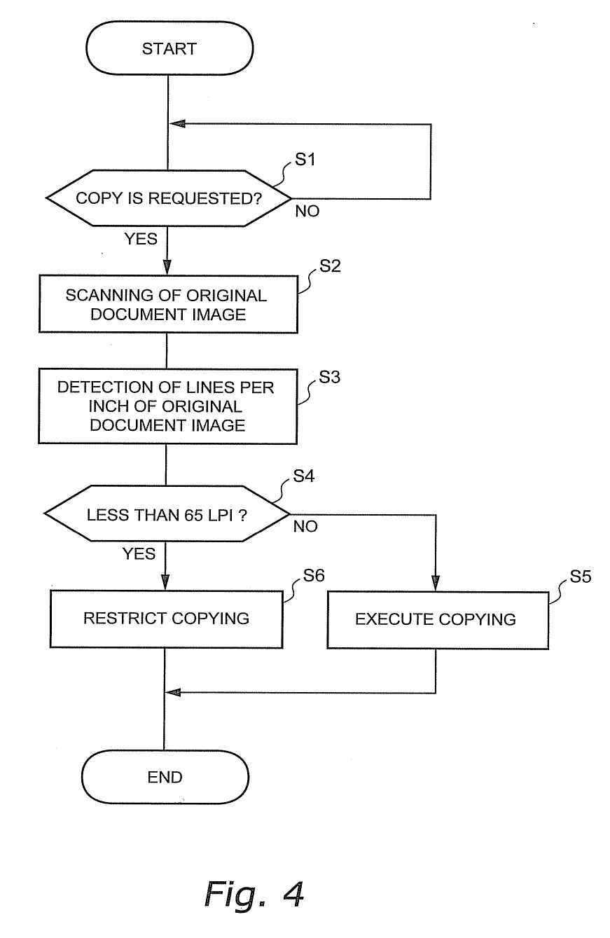

Here, FIG. 1 is a block diagram showing the overall configuration of a multifunction device X according to a first embodiment of the present invention. FIG. 2 is a block diagram showing the system of a lines per inch detector 6 (hereinafter called LPI detector 6) mounted on the multifunction device X. FIG. 3A is a diagram showing a 17×17 matrix Gaussian filter. FIG. 3B is a diagram showing the frequency characteristics of the Gaussian filter. FIG. 4 is a flow chart showing an example of the steps of a copy process executed by a control unit 7 in the multifunction device X.

First, the overall configuration of the multifunction device X in accordance with the first embodiment of the present invention will be explained with reference to FIG. 1. Note that the multifunction device X has a copy function for executing copying of an original document based on an image of the original document obtained by scanning the original document, and is only an example of an image forming device in accordance with the present invention. For example, a copying machine is also an example of an image forming device to which the present invention can be applied. As shown in the block diagram in FIG. 1, the multifunction device X comprises an operation display unit 1, a scanner unit 2, an image processing unit 3, an image forming unit 4, a local area network communication unit 5 (hereinafter called LAN communication unit 5), the LPI detector 6 (an example of a lines per inch detecting unit), and the control unit 7. In addition, the multifunction device X is connected to one or more information processing devices A (e.g., a personal computer) via the LAN communication unit 5 and a local area network 10 (hereinafter called LAN 10), and comprises an image forming system.

The operation display unit 1 is comprised of a liquid crystal display (LCD) displaying various information, a touch panel mounted on the LCD, and the like. The scanner unit 2 comprises an image sensor such as a charge coupled device (CCD), a contact image sensor (CIS), or the like, and scans image data on an original document that is set on an original document tray line by line, and converts the image information into electronic data. The image processing unit 3 executes an image process such as a compression process, density correction, and the like, with respect to the image data that is scanned by the scanner unit 2, or the image data that is received from one of the information processing devices A. The image forming unit 4 transfers a visible image (e.g., a toner image) to a recording medium, based on the image data for which an image process is executed by the image processor 3, and fixes the transferred visible image thereon. In addition, the image forming unit 4 is comprised of various conventional units such as a photosensitive drum, an electrostatic unit for uniformly charging the surface of the photosensitive drum at a predetermined potential, a laser scanning unit (LSU) that forms an electrostatic latent image by exposing and scanning the surface of the photosensitive drum, a developing unit that develops the electrostatic latent image by attaching toner thereto, a transfer unit that transfers the developed toner image onto a recording medium, a fixing unit that fixes the transferred toner image on the recording paper, and the like. The LAN communication unit 5 is comprised of a wired/wireless IEEE 802.3/IEEE 802.11b compliant communication medium/device, and the like, and allows the multifunction device X to communicate with the information processing devices A through the LAN 10.

The LPI detector 6 detects the number of lines per inch included in the image of the original document by executing a Gaussian filter process using a plurality of Gaussian filters with respect to the digital data of the image of the original document scanned by the scanner unit 2. As shown in FIG. 2, the LPI detector 6 is comprised of an image data input unit 61 that inputs the image data scanned by the scanner unit 2 in the LPI detector 6, a Gaussian filter processor 62 (an example of the Gaussian filter processing unit) that executes a Gaussian filter process with respect to the image data input by the image data input unit 61, a distribution value computation processor 63 (an example of a distribution value computation unit) that computes the distribution value of the image data for which a Gaussian filter process is executed by the Gaussian filter processor 62, a lines per inch identifier 64 (an example of a lines per inch identifying unit, and hereinafter referred to as an LPI identifier 64) that identifies the number of lines per inch in the image data based on the distribution value computed by the distribution value computation processor 63, and a processor (not shown in the drawings) that controls the above described units and is comprised of a central processing unit (CPU), a digital signal processor (DSP), and the like. Note that each element of the LPI detector 6 is herein explained as a hardware configuration, but the functions of the LPI detector 6 may be realized by a process that follows the lines per inch detecting program executed by the processor (not shown in the drawings) and the control unit 7. In this configuration, the processor (not shown in the drawings) or the control unit 7, which executes the process, corresponds to the LPI detector.

The Gaussian filter processor 62 is hereinafter explained with reference to FIGS. 3A and 3B. As shown in FIG. 3A, a Gaussian filter 62a comprised of a 17×17 matrix is used in the Gaussian filter processor 62. Each block in the matrix shown herein is corresponds to a pixel, but it is not particularly limited to this configuration. Each block in the matrix may be considered as corresponding to a dot or a group of pixels. FIG. 3B shows a graph 62b that expresses the frequency characteristics of the Gaussian filter 62a. The frequency characteristics graph 62b expresses a power spectrum with respect to the number of lines (i.e., lines per inch: LPI) of the image data after a Gaussian filter process is executed. In the frequency characteristics graph 62b, the horizontal axis corresponds to the number of lines (i.e., lines per inch: LPI) of the image data that is input into the Gaussian filter 62a, and the vertical axis corresponds to the power spectrum of the dot component included in the image data after the Gaussian filter process is executed by the Gaussian filter 62a. The power spectrum is an indication of how many frequency components (dot components) are included in the image data. If this value indicates approximately zero, it means that the dot components included in the image data are completely removed by the Gaussian filter 62a.

The LPI detector 6 detects the number of lines (i.e., lines per inch: LPI) included in the image data as shown in the following steps. First, the image data that is input from the image data input unit 61 is transferred to the Gaussian filter processor 62 by the processor (not shown in the drawings). Because of this, the Gaussian filter processor 62 executes a Gaussian filter process for removing the dot components included in the image data by the Gaussian filter 62a. Next, the distribution value computation processor 63 computes the distribution value of the image data for which the Gaussian filter processor 62 executes a Gaussian filter process. Here, the distribution value means the distribution value generally used in statistics. If the distribution value is set to be σ², as shown in the following formula (1), then the distribution value σ² will be expressed as the square of the average value of the deviation σ of each pixel value (i.e., σ=xᵢ−xₚ) when the average pixel value xᵢ of the 289 pixels that passed through the matrix size (17×17) of the Gaussian filter 62a (e.g., the gradient thereof when expressed in 256 tones) is set to be xₚ.

$$\begin{matrix}Formula ( 1 ) \text{:} & \\ {σ}^{2} = \frac{1}{289} {\sum }_{i = 1}^{289} {( xi - xp )}^{2} & \end{matrix}$$

As shown in formula (1), the distribution value σ² expresses the degree of variation in the pixel value in the image data with the above described matrix size. Therefore, if the distribution value σ² is small, it means that there is little variation in the pixel value, in other words, there is a small tone difference (i.e., density difference) between adjacent pixels. If the distribution value σ² is approximately zero, it means that the pixel value varies little, in other words, there is little tone difference between adjacent pixels. On the other hand, if the distribution value σ² is large, it means that there is a great deal of variation in the pixel value, in other words, there is large tone difference between adjacent pixels. In general, the number of lines (i.e., lines per inch: LPI) is to some extent determined by the quality and application of the paper to be used. For example, approximately 65-85 lines per inch (LPI) is used for newspapers printed on woody paper, approximately 100-133 LPI is used for magazines and books printed on book paper, and approximately 200 LPI is used for art books printed on art paper.

Thus, in the conventional printing field, 65 LPI is adopted as the minimum frequency of lines at which the woody paper with the roughest texture can be printed. In general, a value less than 65 LPI is rarely used for printing. Therefore, a value of less than 65 LPI is adopted as the threshold value of lines per inch in the present invention, which will be described later.

Then, the LPI identifier 64 compares the distribution value σ² with a predetermined threshold k, and determines if the variance σ² is equal to or greater than the threshold k. Thus, it is determined whether something less than 65 LPI is included in the input image data. Here, the threshold k is the distribution value when 65 LPI is employed. As shown by the above described frequency characteristic graph 62b, if image data with less then 65 LPI is input, it will be impossible to thoroughly remove the dot components, even if a Gaussian filter process is executed. In this case, the distribution value σ² will become large and exceed the predetermined threshold k. Therefore, if the distribution value σ² is equal to or greater than the threshold k, it will be determined that the input image data includes something less than 65 LPI. On the other hand, if the distribution value σ² is less than the threshold k, it will be determined that the input image data does not include something that is less than 65 LPI, in other words, it will be determined that the input image data is 65 LPI or greater. Thus, the LPI detector 6 will accurately determine whether the number of lines per inch included in the image data scanned by the scanner unit 2 is less than 65 LPI. In addition, the LPI detector 6 detects the number of lines per inch based on the image data after the Gaussian filter process is executed. Therefore, even if a gradient occurs in the image data of the original document, the accuracy at which the number of lines per inch is detected will not be influenced thereby.

The control unit 7 comprises control devices such as a central processing unit (CPU), a read-only memory (ROM), a random access memory (RAM), and the like, and integrally controls the multifunction device X by executing a process according to a predetermined control program stored in the ROM. Specifically, the control unit 7 executes copying jobs, printing jobs, and the like. The multifunction device X functions to restrict copying of an original document if a predetermined number of lines (i.e., predetermined number of lines per inch) is in the background pattern of the image of the original document obtained by scanning the original document by the scanner unit 2. In this configuration, the value 65 is preset as the restriction number of lines (i.e., the restriction number of lines per inch) in the multifunction device X, so as to be used as a means for determining if copying can be executed in the copy process (refer to the flow chart shown in FIG. 4). Note that 65 or more LPI are used in a normal print process executed by a normal image forming device that forms a part of the above described multifunction device X, and less than 65 LPI are not used in a normal print process.

An example of the steps of a copy process executed by the control unit 7 in the multifunction device X will be explained according to the flow chart shown in FIG. 4. Note that S1 to S6 shown in the figure indicate the process steps. An example of the process is hereinafter explained, which is executed when copying of an original document, including a background pattern having 53 LPI, is requested. Note that 53 LPI is half the value of 106 LPI, which is used when the resolution of the multifunction device X during printing is 600 dots per inch (dpi), and is the number of lines per inch at which a print process can be easily executed. First, in Step S1, the control unit 7 determines if copying is requested. For example, it will be determined whether a user has executed an operation for starting copying through the operation display unit 1. Here, if it is determined that copying is requested (Yes in Step S1), the process will proceed from Step S1 to Step S2.

In Step S2, the control unit 7 controls the scanner unit 2, and the scanner unit 2 scans the original document in order to obtain the image data of the original document (hereinafter called original document image data) that is set on the original document tray. Note that the original document image data includes a 53 LPI background pattern. In addition, in the first embodiment of the present invention, an example of a process for determining whether copying of an original document scanned by the scanner unit 2 is permitted will be explained. However, the same process may be used for determining if the copying of the original document data transmitted from an information processing devices A is permitted.

In Step S3, the control unit 7 controls the LPI detector 6, and the LPI detector 6 detects the number of lines (i.e., lines per inch: lpi) in the background pattern included in the original document image data. Note that as described above, the detection of the number lines per inch is executed by the LPI detector 6 based on the distribution number of the original document image data for which a Gaussian filter process is executed by the Gaussian filter processor 62 with the Gaussian filter 62a. Here, the number of lines in the background pattern is 53 LPI. Therefore, it will be detected that less than 65 LPI are included in the original document image data.

Next, in Step S4, the control unit 7 determines whether or not the number of lines (i.e., lines per inch: LPI) detected by the LPI detector 6 is less than 65 LPI, that is, determines whether or not less than 65 LPI is included in the original document data. Here, it will be detected in Step S3 that less than 65 LPI are included, and thus the determination result is an affirmative determination (Yes in Step S4), and the process will proceed from Step S4 to Step S6. Note that if it is determined that less than 65 LPI is not included in the original document image data in the above described Step S3 (No in Step S4), it will be determined that copying of the original document should not be restricted, and the process will proceed from Step S4 to Step S5. Thus, the original document image data is transmitted to the image forming unit 4 and copying of the original document is executed.

On the other hand, in Step S6, the control unit 7 will restrict copying of the original document, and a so-called grayed-out output will be executed in which the entire image of the original document is grayed-out. Here, the control unit 7 that executes the process corresponds to the copying restriction unit. Note that the copying restriction process executed by the control unit 7 is not limited to grayed-out output. For example, it may be a process of coloring the entire output black or white, or a process of displaying a message that copying of the original document is restricted in the operation display unit 1.

As described above, the multifunction device X can detect the number of lines per inch of the background pattern included in the original document image data obtained by scanning the original document via the scanner unit 2, and can determine if copying of the original document is permitted based on the detected number of lines per inch. Accordingly, the background pattern may be a simple regular pattern in which the number of lines per inch thereof can be identified. In other words, it is not necessary to execute a complicated process such as an analysis of the complex irregular background pattern as executed in the conventional art. Therefore, whether or not copying is permitted can be promptly determined, and thus the time required for executing copying will be reduced. In addition, the multifunction device X does not compare the background pattern embedded in the original document with background patterns stored therein as restriction data as in the conventional art. Therefore, it is not necessary to store a plurality of types of background patterns to be used for comparing the background pattern embedded in the original document, and accordingly it is possible to reduce the size of the storage region.

In addition, for example, if a original document in which the copying thereof is restricted in the multifunction device X is created in one of the information processing devices A, it will not be necessary to embed a complex irregular background pattern in the original document as in the conventional art, and thus a simple background pattern that is less than 65 LPI may be embedded therein. Therefore, original document data that is copy restricted will be output from the information processing devices A to an image forming device such as the multifunction device X or a normal printer device, and the original document data will be promptly printed (e.g., converted to the printer language executed in a printer driver in the information processing devices A or the image forming device), and thus the time required for the print process will be reduced. Note that if the original document image data including a background pattern that is less than 65 LPI is transmitted from one of the information processing devices A to the multifunction device X, it will be necessary to terminate the printing restriction in the original document image data. For example, a configuration can be considered in which the printing restriction will be terminated by inputting and verifying a predetermined personal identification number when the original document image data is output from the information processing devices A to the multifunction device X. Of course, a configuration can also be considered in which the printing restriction will not be executed when the image data is output from the information processing devices A.

### Second Embodiment

As shown in FIG. 3B, after the Gaussian filter processor 62 executes a Gaussian filter processing for 65 LPI image data, the power spectrum of the image data after the process is executed will be 0.2. On the other hand, if the number of lines is less than 65 LPI, the power spectrum of the image data after the process is executed will be greater than 0.2.

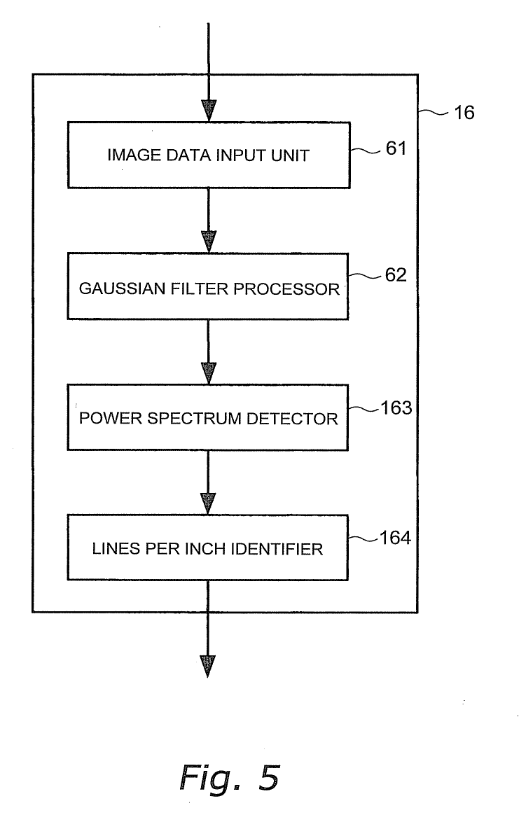

Therefore, a configuration can also be considered in which a lines per inch detector 16 (hereinafter referred to as a LPI detector 16) that detects the number of lines per inch by determining whether the power spectrum of the image data after the Gaussian filter process is executed is greater than 0.2 may be used instead of the LPI detector 6. Here, FIG. 5 is a block diagram showing the system of the LPI detector 16.

As shown in FIG. 5, the LPI detector 16 is comprised of an image data input unit 61, a Gaussian filter processor 62, a power spectrum detector 163 that detects the power spectrum of the original document image data for which a Gaussian filter processing is executed by the Gaussian filter processor 62, a lines per inch identifier 164 (hereinafter called a LPI identifier 164) that identifies the number of lines per inch included in the image data based on the detected power spectrum detected by the power spectrum detector 163, and a processor (not shown in the drawings) that controls the above described units and is comprised of a central processing unit (CPU), a digital signal processor (DSP), and the like.

Note that each element of the LPI detector 16 is herein explained as a hardware configuration, but the functions of the LPI detector 16 may be also be realized by a process that follows the lines per inch detecting program executed by the processor (not shown in the drawings) and the control unit 7. In this configuration, the processor (not shown in the drawings), or the control unit 7 which executes the process, corresponds to the LPI detector.

The LPI detector 16 detects the number of lines per inch included in the image data as shown in the following steps.

First, the image data that is input from the image data input unit 61 is transferred to the Gaussian filter processor 62 by the processor (not shown in the drawings).

Next, the Gaussian filter processor 62 executes a Gaussian filter process for removing the dot components included in the image data by the Gaussian filter 62a. Next, the power spectrum detector 163 detects the power spectrum of the image data for which the Gaussian filter processor 62 executes a Gaussian filter process.

Then, the LPI identifier 164 determines whether or not the power spectrum is greater than 0.2, and thereby determines that less than 65 LPI are included in the input image data.

### Third Embodiment

In the above described first and second embodiments, if the distribution value σ² is equal to or greater than the threshold k, or if the power spectrum is greater than 0.2, the number of lines will be determined to be less than 65 LPI, and thus copying of the original document will be restricted. However, it is also possible for the number of lines per inch that will indicate this determination to be set within a predetermined range.

For example, copying of an original document can be restricted by setting the range of the lines per inch to 30-60 LPI, and setting the distribution value σ² to the corresponding predetermined distribution value range of m and n (e.g., corresponding to a range of 30-60 LPI) and setting the power spectrum to the corresponding predetermined power spectrum range of p and q (e.g., corresponding to a range of 30-60 LPI) as the range in which copying will be inhibited.

In addition, the range of the number of lines (i.e., lines per inch) of the input image data may be identified by executing a Gaussian filter process by means of the Gaussian filter processor 62 with a plurality of Gaussian filters with different size matrices, and then comparing the predetermined distribution value (or the power spectrum) with each distribution value (or power spectrum) of the image data after the process is performed (see, for example, Japan Patent Application Publication JP-2004-295318). In this case, copying of the original document may be restricted when the identified range is included in the predetermined range of the number of lines per inch.

As described above, it is not necessary to execute a complicated process such as an analysis of a complex irregular background pattern as performed in the conventional art, and copying of the original document can be restricted based on the number of lines per inch of the background pattern. Therefore, whether or not copying can be executed can be promptly determined, and thus it will be possible to reduce the time required to execute copying. In other words, the background pattern may be a simple regular pattern so long as the number of lines per inch thereof can be determined. In addition, it will not be necessary to store a plurality of types of restriction data (i.e., a plurality of types of background patterns) in order to restrict copying of the original document. Therefore, it will be possible to reduce the storage region for storing the information.

Furthermore, it will not be necessary to execute a complicated process for comparing the background pattern included in the original document image with the restriction data. Therefore, the process steps for determining whether the copying of the original document is permitted can be simplified, and the circuit configuration can be simplified. Furthermore, in the conventional art, when the information processing device such as a personal computer instructs an image forming device such as a printer to print an original document in which a background pattern is embedded, that is, when an original document is created in which the copying thereof is restricted, the steps in the printing, such as the process of converting into the printer language, will be delayed if the background pattern is a complicated irregular pattern, and accordingly the printing will not be promptly executed. However, according to the present invention, the background pattern can be expressed by a simple regular pattern. Therefore, the printing steps will not be delayed, and thus it will be possible to promptly print an original document in which the copying thereof is restricted.

In addition, copying of the original document can be restricted when the predetermined number of lines per inch is less than the detected number of lines per inch. Here, the restriction lines per inch can be a number of lines that is not normally used in printing by the image forming device. As described above, less than 65 LPI can be suggested as an example of the number of lines. In general, less than 65 LPI is rarely used in an image forming device, and thus it is preferred for the versatility thereof.

Moreover, the number of lines per inch of the background pattern can be easily detected by executing a Gaussian filter process for the digital data that represents the original document image, and computing the distribution value of the digital data after the Gaussian filter processing is executed, and then identifying the number of lines per inch of the background pattern included in the original document image represented by the digital data based on the distribution value. In this configuration, the number of lines per inch is detected based on the image data after a Gaussian filter processing is executed. Therefore, even if a gradient occurs in the original document image data, the detection accuracy of the number of lines per inch will not be influenced thereby.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An image forming device configured to copy an original document based on an original document image obtained by scanning the original document, comprising:
a detector configured to detect the number of lines per inch in a background pattern included in the original document image; and
a copy restriction unit configured to restrict copying of the original document based on the number of lines per inch detected by the detector.

2. The image forming device according to claim 1, wherein the copying restriction unit will restrict copying of the original document when the number of lines per inch detected by the detector is less than or equal to a predetermined restriction number of lines per inch.

3. The image forming device according to claim 2, wherein the restriction number of lines per inch is an unused number of lines per inch that is not normally used in printing by the image forming device.

4. The image forming device according to claim 3, wherein the unused number of lines per inch is less than 65 lines per inch.

5. The image forming device according to claim 1, wherein the detector is comprised of: a Gaussian filter processor configured to execute a Gaussian filter process with respect to digital data that represents the original document image;
a distribution value computation unit configured to compute a distribution value of the digital data for which the Gaussian filter process was executed by the Gaussian filter processor; and
a lines per inch identifier configured to identify the number of lines per inch of the background pattern included in the original document image represented by the digital data, based on the distribution value computed by the distribution value computation unit.
